(19) United States
(12) Patent Application Publication
(10) Pub. No.: US 2026/0026434 A1
(43) Pub. Date: Jan. 29, 2026

(54) LIFTING MECHANISM AND MOWING DEVICE

(71) Applicant: SHENZHEN MAMMOTION INNOVATION CO., LIMITED, Shenzhen (CN)

(72) Inventors: Jidong WEI, Shenzhen (CN); Yuanjun XU, Shenzhen (CN); Chuanhua LAI, Shenzhen (CN)

(21) Appl. No.: 19/350,351

(22) Filed: Oct. 6, 2025

Related U.S. Application Data
(63) Continuation-in-part of application No. PCT/CN2024/087377, filed on Apr. 12, 2024.

(30) Foreign Application Priority Data
Apr. 14, 2023 (CN) 202320935908.6

(51) Int. Cl. A01D 34/74; A01D 34/64; A01D 34/78; A01D 34/82; A01D 101/00

(52) U.S. Cl. CPC A01D 34/74; A01D 34/64; A01D 34/82; A01D 34/78; A01D 2101/00

(57) ABSTRACT

A lifting mechanism and a mowing device provided. The lifting mechanism is used for mowing device. The lifting mechanism comprises a swing arm and an adjustment assembly. The swing arm is mounted on the mowing device and can swing relative to the mowing device. The adjustment assembly comprises a fixing frame, a rotating shaft and a cord. The fixing frame is fixedly mounted on the mowing device. The rotating shaft is rotatably mounted on the fixing frame and is movable relative to the fixing frame between a first position and a second position. A first end of the cord is connected to the rotating shaft, and a second end of the cord is connected to the swing arm.

### CROSS-REFERENCE TO RELATED APPLICATIONS

The present application is a continuation of International Application No. PCT/CN2024/087377, filed on Apr. 12, 2024, which claims priority to Chinese patent application No. 202320935908.6, filed with the Chinese Patent Office on Apr. 14, 2023, and entitled “LIFTING MECHANISM AND MOWING DEVICE”, the entire disclosures of which are incorporated herein by reference.

### TECHNICAL FIELD

The disclosure relates to the technical field of lifting machinery, and in particular to a lifting mechanism and a mowing device.

### BACKGROUND

When a lawn mower is mowing, users may have different requirements for the mowing height. Generally, the mowing height can be controlled by adjusting the height of the cutter disc from the ground. Therefore, the lawn mower needs to be equipped with a height adjustment mechanism to adjust the height of the cutter disc from the ground.

The existing lawn mower directly drives the lifting and lowering of the cutter disc by a motor. Although the motor drive will be more accurate and relatively easy to adjust, the cost of the motor drive is relatively high, the overall lawn mower is heavier, and the subsequent motor maintenance costs will also be higher. Of course, there are also some lawn mowers that can control the lifting and lowering of the cutter disc through a manually adjustable structure. It is generally controlled by a spiral method, which has a more complex structure and poor accuracy.

### SUMMARY

The disclosure provides a lifting mechanism and a mowing device. The lifting mechanism is configured to control the mowing height of the mowing device, which offers easy adjustment, high control accuracy, and robust stability.

In a first aspect, the disclosure provides a lifting mechanism for use in mowing device. The lifting mechanism comprises:
a swing arm being configured to swing relative to the mowing device, the swing arm mounted on the mowing device; and
an adjustment assembly, where the adjustment assembly comprises a fixing frame, a rotating shaft, and a cord, the fixing frame is fixedly mounted on the mowing device, the rotating shaft is rotatably mounted on the fixing frame and is movable relative to the fixing frame between a first position and a second position. A first end of the cord is connected to the rotating shaft, and a second end of the cord is connected to the swing arm;
when the rotating shaft is in the first position, the rotating shaft is locked relative to the fixing frame; and
when the rotating shaft is in the second position, the rotating shaft is configured to rotate relative to the fixing frame to drive the cord to actuate swinging of the swing arm.

In a second aspect, the disclosure provides a mowing device. The mowing device comprises a vehicle body, a motor, a cutter disc, and the preceding lifting mechanism. The adjustment assembly is mounted on the vehicle body. A first end of the swing arm is connected to the vehicle body in a swinging manner, and a second end of the swing arm is connected to the motor. The cutter disc is mounted on the motor.

The mowing device in an embodiment of the disclosure can better control the height of the cutter disc from the ground through the lifting mechanism, thereby better controlling the mowing height of the mowing device with high control accuracy.

### BRIEF DESCRIPTION OF DRAWINGS

In order to illustrate the technical solution of an embodiment of the disclosure, the drawings required for use in the embodiment of the disclosure will be described below.

FIG. 1 is a schematic diagram illustrating a structure of the mowing device according to an embodiment of the disclosure.

FIG. 2 is a partial cross-sectional view of an embodiment of the mowing device shown in FIG. 1 at line A-A.

FIG. 3 is a partially exploded view of an embodiment of the adjustment assembly shown in FIG. 1.

FIG. 4 is a schematic diagram illustrating a structure of the adjustment assembly shown in FIG. 3 at another angle.

FIG. 5 is a schematic diagram illustrating a structure of an embodiment of the adjustment assembly shown in FIG. 1 at another angle.

FIG. 6 is a partial enlarged view of the mowing device shown in FIG. 2 at B.

FIG. 7 is a partial cross-sectional view of an embodiment of the mowing device shown in FIG. 1 at the C-C line.

FIG. 8 is a partial exploded view of the partial structure of the mowing device shown in FIG. 1.

FIG. 9 is a partial schematic diagram of the mowing device shown in FIG. 1.

FIG. 10 is a schematic diagram illustrating a structure of the mowing device shown in FIG. 9 at different angles.

### DETAILED DESCRIPTION OF THE EMBODIMENTS

In the description of the embodiments of the disclosure, it should be noted that unless otherwise clearly specified and limited, the term “connection” should be understood in a broad sense. For example, “connection” can be detachably connected or non-detachably connected; it can be directly connected or indirectly connected through an intermediate medium. The term “integral molding” means that in the process of forming one of the plurality of components, the component is connected to other components without the need for reprocessing (such as bonding, welding, snap-on connection, screw connection) to connect the two components together. The orientation terms mentioned in the embodiment of the disclosure, such as “upper”, “inside”, “top”, “bottom”, “side”, etc., are only for a direction of reference to the accompanying drawings. Therefore, the orientation terms used are for better and clearer explanation and understanding of the embodiment of the disclosure, rather than indicating or implying that the device or component referred to must have a specific orientation, be constructed and operated in a specific orientation, and therefore cannot be understood as limiting the embodiment of the disclosure. The following terms, including “first” and “second”, are used merely for illustrative purposes and shall not be construed as indicating or implying relative importance or as implicitly specifying the number of technical features indicated. Thus, the features defined with the terms “first” and “second” may explicitly or implicitly include one or more of these features. “A plurality of” means at least two.

The embodiments of the disclosure are described below in conjunction with the accompanying drawings in the embodiments of the disclosure.

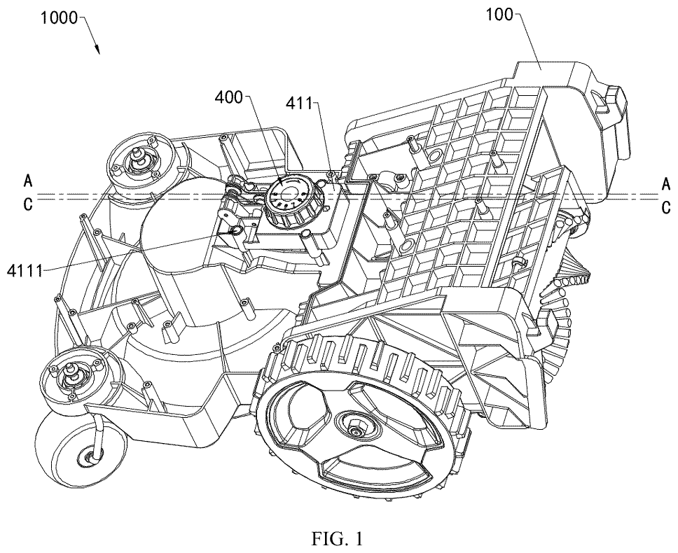

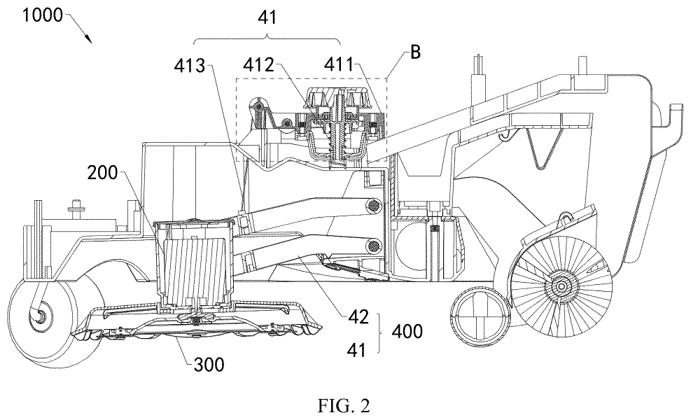

FIG. 1 is a schematic diagram illustrating a structure of a mowing device 1000 according to an embodiment of the disclosure. FIG. 2 is a partial cross-sectional view of an embodiment of the mowing device 1000 shown in FIG. 1 at line A-A.

As shown in FIGS. 1 and 2, the mowing device 1000 may be a lawn mower. The mowing device 1000 may include a vehicle body 100, a motor 200, a cutter disc 300, and a lifting mechanism 400. The cutter disc 300 can be mounted on the motor 200. Exemplarily, the cutter disc 300 can be mounted on the bottom of the motor 200. The motor 200 is configured to drive the cutter disc 300 to rotate and perform mowing.

As shown in FIGS. 1 and 2, the lifting mechanism 400 comprises a swing arm 42 and an adjustment assembly 41. The adjustment assembly 41 can be mounted on the vehicle body 100. The swing arm 42 can be mounted on the mowing device 1000 and can swing relative to the mowing device 1000. The swing arm 42 is further connected to the motor 200.

It can be understood that when the mowing device 1000 is mowing, the swing arm 42 can swing relative to the vehicle body 100 under the action of the adjustment assembly 41, and drive the motor 200 and the cutter disc 300 to move relative to the vehicle body 100 along the height direction of the mowing device 1000 to adjust the height of the cutter disc 300 from the ground, so as to better control the mowing height of the mowing device 1000 with higher control accuracy to meet the different requirements of users for mowing height.

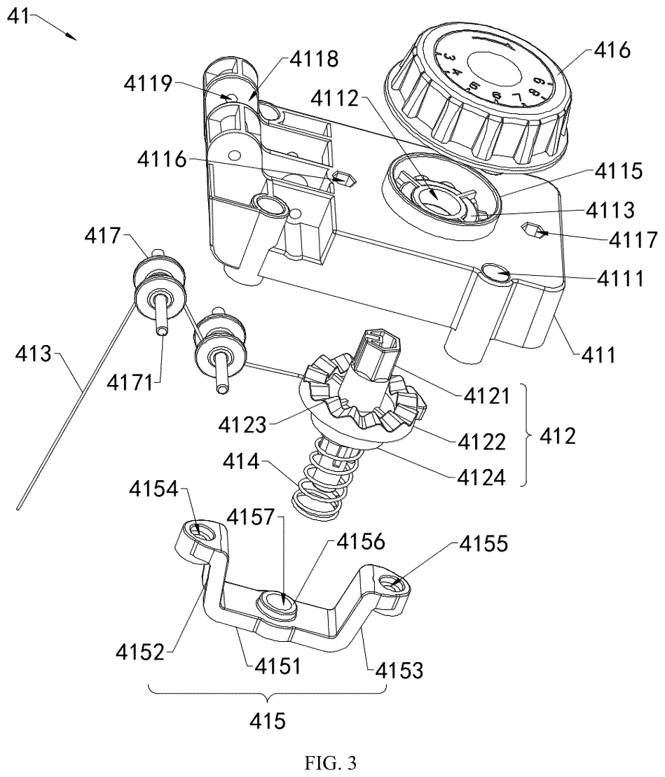

FIG. 3 is a partially exploded view of an embodiment of the adjustment assembly 41 shown in FIG. 1.

As shown in FIGS. 1 to 3, the adjustment assembly 41 comprises a fixing frame 411, a rotating shaft 412, and a cord 413. Among them, the fixing frame 411 is fixedly mounted on the vehicle body 100. Exemplarily, the fixing frame 411 can be provided with a fastening hole 4111. The fixing frame 411 can be fixedly mounted on the vehicle body 100 by fasteners (for example, screws) passing through the fastening holes 4111. The rotating shaft 412 can be inserted into the fixing frame 411 and rotate relative to the fixing frame 411. When the rotating shaft 412 rotates relative to the fixing frame 411, the rotating shaft 412 can tighten the cord 413 or loosen the cord 413, thereby the cord 413 is wound around the rotating shaft 412 or detached from the rotating shaft 412, thereby driving the swing arm 42 to swing relative to the vehicle body 100, and then the swing arm 42 drives the motor 200 and the cutter disc 300 away from or close to the ground along the height direction of the mowing device 1000. The mowing device 1000 has different mowing heights.

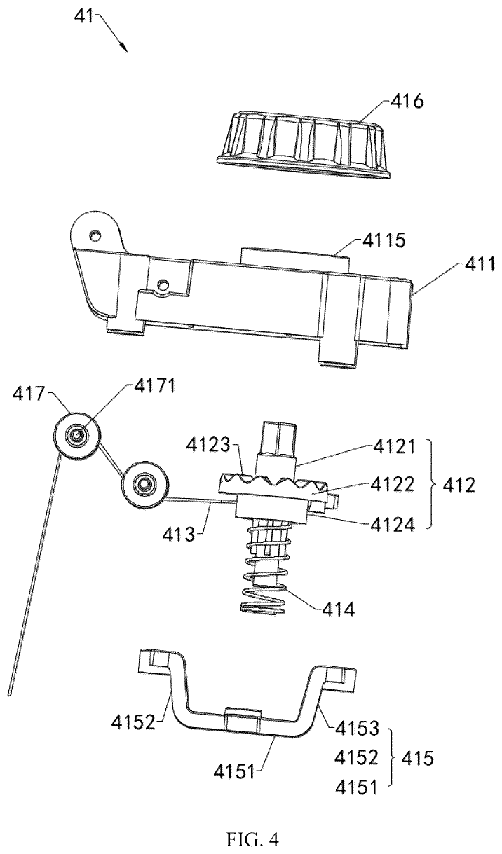

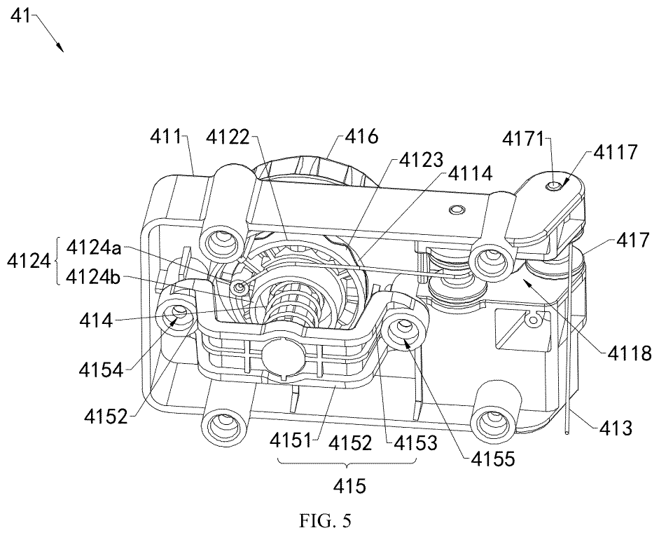

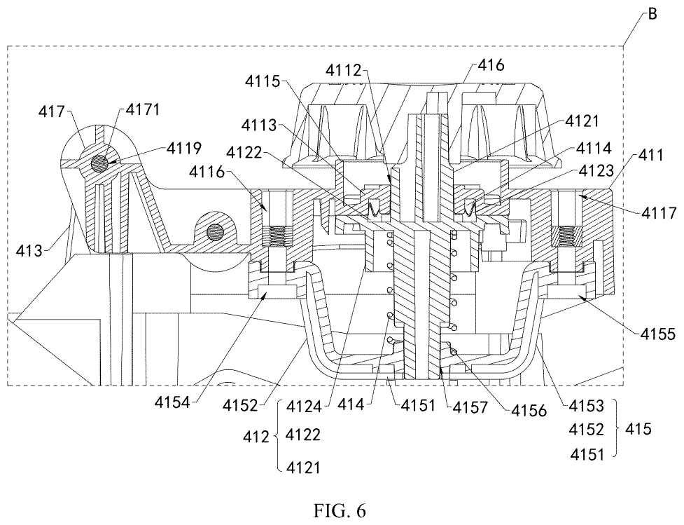

FIG. 4 is a partial exploded view of the adjustment assembly 41 shown in FIG. 3 at another angle. FIG. 5 is a schematic diagram illustrating a structure of an embodiment of the adjustment assembly 41 shown in FIG. 1 at another angle. FIG. 6 is a partial enlarged view of the mowing device 1000 shown in FIG. 2 at B.

As shown in FIGS. 3 to 6, the rotating shaft 412 is rotatably mounted on the fixing frame 411. It can be understood that the rotating shaft 412 is mounted on the fixing frame 411 and can rotate relative to the fixing frame 411. The rotating shaft 412 is movable relative to the fixing frame 411 between a first position and a second position. For example, the rotating shaft 412 can slide between a first position and a second position relative to the fixing frame 411. Among them, the first position and the second position are the positions where the rotating shaft 412 is located relative to the fixing frame 411, and the first position and the second position can be arranged along the axial direction of the rotating shaft 412. When the rotating shaft is in the second position, the rotating shaft 412 can rotate relative to the fixing frame 411.

Exemplarily, the fixing frame 411 is provided with a through hole 4112. The rotating shaft 412 can be inserted into the through hole 4112 of the fixing frame 411.

It can be understood that the rotating shaft 412 can be inserted into the through hole 4112 of the fixing frame 411, thereby the rotating shaft 412 can rotate relative to the fixing frame 411, and the rotating shaft 412 can slide relative to the fixing frame 411 along the axial direction of the rotating shaft 412.

Exemplarily, the rotating shaft 412 may include a shaft body 4121 and a locking portion 4122. The locking portion 4122 is arranged around the shaft body 4121. The locking portion 4122 is fixedly connected to the shaft body 4121. The fixing frame 411 is provided with a stop portion 4113. The stop portion 4113 is arranged around the through hole 4112 of the fixing frame 411.

The disclosure provides a stop portion 4113 on the fixing frame 411 and a locking portion 4122 on the rotating shaft 412, thereby when the rotating shaft 412 is in the first position, the stop portion 4113 can be engaged with the locking portion 4122 to lock the rotating shaft 412 relative to the fixing frame 411; when the rotating shaft 412 is in the second position, the stop portion 4113 can be disengaged from the locking portion 4122 thereby the rotating shaft 412 can rotate relative to the fixing frame 411.

Exemplarily, the locking portion 4122 may have a plurality of first teeth 4123. A plurality of first teeth 4123 circumferentially arranged along the rotating shaft 412. The stop portion 4113 may have a plurality of second teeth 4114 opposite to the first teeth 4123 of the locking portion 4122.

Exemplarily, the plurality of second teeth 4114 can be engaged with the plurality of first teeth 4123. It can be understood that when the rotating shaft 412 is in the first position, the plurality of second teeth 4114 are engaged with the plurality of first teeth 4123. At the moment, the locking portion 4122 and the stop portion 4113 can be snap-fitted thereby the rotating shaft 412 is locked relative to the fixing frame 411, and the rotating shaft 412 cannot rotate relative to the fixing frame 411.

It can be understood that by providing a plurality of first teeth 4123 and a plurality of second teeth 4114, the engagement of the plurality of first teeth 4123 with the plurality of second teeth 4114 can make the connection between the locking portion 4122 and the stop portion 4113 more stable.

In an embodiment, the plurality of second teeth 4114 can be disengaged from the plurality of first teeth 4123. It can be understood that when the rotating shaft 412 is in the second position, the plurality of second teeth 4114 are disengaged from the plurality of first teeth 4123. At the moment, the locking portion 4122 and the stop portion 4113 can be disengaged, and the rotating shaft 412 can rotate relative to the fixing frame 411.

It is understood that the rotating shaft 412 can slide from a first position to a second position relative to the fixing frame 411, thereby the plurality of second teeth 4114 can be disengaged from the plurality of first teeth 4123, and the rotating shaft 412 can rotate relative to the fixing frame 411. The rotating shaft 412 can slide from the second position to the first position relative to the fixing frame 411, thereby the plurality of second teeth 4114 can be engaged with the plurality of first teeth 4123, and the rotating shaft 412 is locked relative to the fixing frame 411.

In other embodiments, the locking portion 4122 and the stop portion 4113 can be relatively fixed by other means, for example, the locking portion 4122 and the stop portion 4113 can contact and be relatively fixed by friction.

As shown in FIGS. 3 to 6, the adjustment assembly 41 may further include a support frame 415. The support frame 415 is fixedly connected to the fixing frame 411.

Exemplarily, the support frame 415 comprises a bottom wall 4151, a first connecting arm 4152, and a second connecting arm 4153. The first connecting arm 4152 and the second connecting arm 4153 are respectively connected to both ends of the bottom wall 4151 and bent toward the fixing frame 411. The first connecting arm 4152 and the second connecting arm 4153 are fixedly connected to the fixing frame 411.

Exemplarily, the first connecting arm 4152 may have a first fixing hole 4154. The fixing frame 411 may have a second fastening hole 4116. Fasteners (for example, screws or latches) can pass through the first fixing hole 4154 and the second fastening hole 4116 of the fixing frame 411, thereby the first connecting arm 4152 is fixedly connected to the fixing frame 411. The second connecting arm 4153 may have a second fixing hole 4155. The fixing frame 411 may have a third fastening hole 4117. The third fastening hole 4117 and the second fastening hole 4116 are arranged at intervals. The fastener can pass through the second fixing hole 4155 and the third fastening hole 4117 of the fixing frame 411, thereby the second connecting arm 4153 is fixedly connected to the fixing frame 411.

As shown in FIGS. 3 to 6, the adjustment assembly 41 may further include an elastic part 414. The two ends of the elastic part 414 can be respectively abutted against the locking portion 4122 and the support frame 415. The elastic part 414 can be sleeved on the rotating shaft 412 and exerts an elastic force to slide the rotating shaft 412 from the second position to the first position, thereby the rotating shaft 412 is maintained in the first position without external force for better locking, thereby improving the stability of the cutter disc 300 when locked.

Exemplarily, the elastic part 414 can be sleeved on the shaft body 4121 of the rotating shaft 412 and is located on the side of the locking portion 4122 facing away from the stop portion 4113. The bottom wall 4151 of the fixing frame 411 can be located on the side of the locking portion 4122 facing away from the fixing frame 411. The elastic part 414 is in a compressed state and can be held between the locking portion 4122 and the bottom wall 4151 of the support frame 415.

It can be understood that the disclosure provides an elastic part 414, and the elastic part 414 exerts an elastic force to slide the rotating shaft 412 from the second position to the first position, thereby the locking portion 4122 can be engaged with the stop portion 4113 under the action of the elastic force of the elastic part 414, thereby locking the rotating shaft 412 relative to the fixing frame 411. In addition, when the rotating shaft 412 is in the first position, the elastic force of the elastic part 414 makes the locking state of the locking portion 4122 and the stop portion 4113 more stable, and the locking portion 4122 and the stop portion 4113 are not easy to disengage.

It can be understood that in the disclosure, by setting a support frame 415, both ends of the elastic part 414 can respectively abut against the locking portion 4122 and the support frame 415, thereby the elastic part 414 can be in a compressed state and exerts an elastic force on the rotating shaft 412 to slide it from the second position to the first position.

Exemplarily, a protrusion 4156 may be provided on the bottom wall 4151 of the support frame 415. A first end of the elastic part 414 can be sleeved on the protrusion 4156 of the bottom wall 4151 of the support frame 415. In this way, the elastic part 414 can be restricted from sliding on the bottom wall 4151 of the support frame 415, and the elastic part 414 is more stably held between the locking portion 4122 and the bottom wall 4151, and is not easy to fall off.

In an embodiment, when the rotating shaft 412 is in the second position, a first end of the rotating shaft 412 sleeved with the elastic part 414 can be abutted against the bottom wall 4151 of the support frame 415 to prevent the rotating shaft 412 from detaching from the fixing seat. Exemplarily, a groove 4157 may be provided on the protrusion 4156 of the support frame 415. When the rotating shaft 412 is in the second position, a portion of a first end of the rotating shaft 412 sleeved with the elastic part 414 can extend into the groove 4157 of the protrusion 4156. In this way, the groove 4157 of the support frame 415 can limit the rotating shaft 412, and the rotating shaft 412 is not easy to fall off.

In other embodiments, the adjustment assembly 41 may not include the support frame 415. The two ends of the elastic part 414 can be respectively abutted against the locking portion 4122 and the vehicle body 100.

As shown in FIGS. 3 to 6, the rotating shaft 412 can be further provided with a cord roller portion 4124. A first end of the cord 413 can be connected to the cord roller portion 4124. The cord 413 can be at least partially wound around the cord roller portion 4124. Exemplarily, the cord roller portion 4124 can be arranged around the shaft body 4121. The cord roller portion 4124 can be located on the side of the locking portion 4122 facing away from the fixing seat and connected to the locking portion 4122.

It can be understood that the shaft body 4121, the locking portion 4122 and the cord roller portion 4124 can be an integrally molded structural parts. The shaft body 4121, the locking portion 4122, and the cord roller portion 4124 can be formed into an integral structural member by splicing (such as mortise and tenon process) or fixing (such as welding or bonding). Specifically, the disclosure is not limited.

In an embodiment, the cord roller portion 4124 may include a connecting portion 4124a and a winding portion 4124b. The connecting portion 4124a and the winding portion 4124b are arranged at intervals. A first end of the cord 413 can be fixedly connected to the connecting portion 4124a. The cord 413 can be at least partially wound around the winding portion 4124b.

The disclosure provides a cord roller portion 4124 on the rotating shaft 412, thereby the cord 413 can be released and reeled more smoothly relative to the rotating shaft 412, avoiding the cord 413 from being tangled during the reeling process, which affects the lifting and lowering of the cutter disc 300.

As shown in FIGS. 3 to 6, the adjustment assembly 41 may further include an adjustment button 416. Exemplarily, the adjustment button 416 can be located on the side of the fixing frame 411 away from the elastic part 414. The rotating shaft 412 can pass through the through hole 4112 of the fixing frame 411 and at least partially extend out of the through hole 4112 of the fixing frame 411. The adjustment button 416 can be mounted on the extended end of the rotating shaft 412 and spaced apart from the fixing frame 411.

It can be understood that a user can slide the rotating shaft 412 from the first position to the second position relative to the fixing frame 411 by pressing the adjustment button 416, thereby the locking portion 4122 of the rotating shaft 412 is disengaged from the stop portion 4113 of the fixing frame 411. Then, the user can drive the rotating shaft 412 to rotate relative to the fixing frame 411 by rotating the adjustment button 416.

Exemplarily, the surface of the adjustment button 416 can be provided with a plurality of gear marks. Each gear corresponds to a preset height of the cutter disc 300 from the ground. In this way, the user can rotate the adjustment button 416 according to the mark to adjust the height of the cutter disc 300 from the ground.

According to the disclosure, a rotating shaft is rotatably mounted on a fixing frame, and the rotating shaft is movable relative to the fixing frame between a first position and a second position, thereby when the rotating shaft is in the first position, the rotating shaft is locked relative to the fixing frame; when the rotating shaft is in the second position, the rotating shaft is configured to rotate relative to the fixing frame to drive the cord to actuate swinging of the swing arm. In this way, on the one hand, the lifting mechanism configured to realize the lifting function of the cutter disc through the engagement of the rotating shaft, the cord, and the swing arm. With relatively simple overall structure and manufacturing process, the lifting mechanism is easy to mount, with an effectively reduced cost. On the other hand, the lifting mechanism is easy to adjust, has good control accuracy and strong stability.

In a possible embodiment, the fixing frame is provided with a stop portion, and the rotating shaft is provided with a locking portion. When the rotating shaft is in the first position, the stop portion is engaged with the locking portion to lock the rotating shaft. When the rotating shaft is in the second position, the stop portion is disengaged from the locking portion to allow the rotating shaft to rotate.

The disclosure provides a stop portion on the fixing frame and a locking portion on the rotating shaft, thereby when the rotating shaft is in the first position, the stop portion is configured to be engaged with the locking portion to lock the rotating shaft relative to the fixing frame; when the rotating shaft is in the second position, the stop portion is configured to be disengaged from the locking portion to enable the rotating shaft to rotate relative to the fixing frame.

In a possible embodiment, the locking portion has a plurality of first teeth circumferentially arranged along the rotating shaft, and the stop portion has a plurality of second teeth opposite to the first teeth;
when the rotating shaft is in the first position, a plurality of first teeth are disengaged from the plurality of second teeth; and
when the rotating shaft is in the second position, the plurality of first teeth are disengaged from the plurality of second teeth.

The disclosure sets a plurality of first teeth and a plurality of second teeth. On the one hand, the engagement of the plurality of first teeth with the plurality of second teeth is configured to make the connection between the locking portion and the stop portion more stable; on the other hand, since the rotating shaft and the fixing frame are gear-matched, the rotating shaft rotates relative to the fixing frame in a stepped manner. The lifting mechanism is configured to adjust the mowing height of the cutter disc in stages according to the established design requirements. Specifically, the rotation angle of the rotating shaft relative to the fixing frame is a number of fixed values, and the rotating shaft rotates relative to the fixing frame at a certain rotation angle, thereby the cord can have a preset contraction length, thereby the swing arm can swing relative to the vehicle body at a preset angle, and then the motor and the cutter disc can be at a preset height from the ground.

In a possible embodiment, the adjustment assembly further comprises an elastic part. The elastic part is sleeved on the rotating shaft and exerts an elastic force on the rotating shaft to slide it from the second position to the first position.

The disclosure provides an elastic part. The elastic part exerts an elastic force on the rotating shaft to slide it from the second position to the first position, thereby the locking portion can be engaged with the stop portion under the action of the elastic force of the elastic part. In addition, when the rotating shaft is in the first position, the elastic force of the elastic part makes the locking state of the locking portion and the stop portion more stable, and the locking portion and the stop portion are not easy to separate.

In a possible embodiment, the adjustment assembly further comprises a support frame. The support frame is fixedly connected to the fixing frame, and the two ends of the elastic part are respectively abutted against the locking portion and the support frame.

The disclosure provides a support frame, and the two ends of the elastic part can respectively abut against the locking portion and the support frame, thereby the elastic part can be in a compressed state, and exerts an elastic force on the rotating shaft to slide it from the second position to the first position, thereby the rotating shaft is kept in the first position without external force for better locking, thereby improving the stability of the cutter disc when locked.

In a possible embodiment, the support frame comprises a bottom wall, a first connecting arm, and a second connecting arm. The first connecting arm and the second connecting arm are respectively connected to both ends of the bottom wall and bent toward the fixing frame; and
the first connecting arm and the second connecting arm are fixedly connected to the fixing frame, the bottom wall is located on the side of the locking portion facing away from the fixing frame, and the elastic part is supported between the bottom wall and the locking portion.

In a possible embodiment, the rotating shaft is further provided with a cord roller portion, A first end of the cord is connected to the cord roller portion, and the cord is at least partially wound around the cord roller portion.

The disclosure provides a cord roller portion on the rotating shaft, thereby the cord can be released and reeled more smoothly relative to the rotating shaft, avoiding the cord from being tangled during the reeling process, which affects the lifting and lowering of the cutter disc.

In a possible embodiment, a guide portion is provided on the fixing frame, and the cord is wound around the guide portion to change a direction of the tension between the cord and the swing arm.

The disclosure provides a guide portion. The guide portion can change a direction of tension between the cord and the swing arm, so as to better guide the winding of the cord on the rotating shaft and pull the swing arm to swing more smoothly, making it more labor-saving when pulling the swing arm.

In a possible embodiment, the adjustment assembly further comprises an adjustment button, the fixing frame is provided with a through hole, the rotating shaft extends through the through hole and at least partially extends out of the through hole, and the adjustment button is mounted on an extended end of the rotating shaft and is spaced apart from the fixing frame.

The disclosure provides an adjustment button. The adjustment button is mounted on an extended end of the rotating shaft and is spaced apart from the fixing frame. A user can press the adjustment button to make the rotating shaft slide from the first position to the second position relative to the fixing frame, thereby the locking portion and the stop portion are disengaged. Then, by rotating the adjustment button, the user can drive the rotating shaft to turn relative to the fixing frame.

As shown in FIGS. 3, 4 and 6, in an embodiment, the fixing frame 411 can be further provided with an annular protrusion 4115. The annular protrusion 4115 can be arranged around the stop portion 4113. The annular protrusion 4115 can be directed toward the adjustment button 416. In this way, dust, water vapor, and so on can be prevented from entering the through hole 4112 of the fixing frame 411 from the gap between the adjustment button 416 and the fixing frame 411.

As shown in FIGS. 3 to 6, the fixing frame 411 can be further provided with a guide portion 417. The guide portion 417 is fixedly connected to the fixing frame 411.

Exemplarily, the fixing frame 411 can be provided with a mounting groove 4118. The guide portion 417 can be located in the mounting groove 4118.

Exemplarily, the fixing frame 411 can be provided with a fixing hole 4119. The fixing hole 4119 can be located on the side wall of the mounting groove 4118. The guide portion 417 may be provided with a fixed shaft 4171. At least part of the fixed shaft 4171 of the guide portion 417 can be located in the fixing hole 4119 of the fixing frame 411. In other embodiments, the side wall of the mounting groove 4118 of the fixing frame 411 can be provided with a fixed shaft. The guide portion 417 may be provided with a fixing hole. At least part of the fixing axis of the fixing frame 411 can be located in the fixing hole of the guide portion 417.

Exemplarily, the guide portion 417 can be a pulley. In other embodiments, the guide portion 417 may be a structure such as a columnar cord groove.

It is understood that the quantity of guide portion 417 can be one or more. When there are plurality of guide portions 417, the plurality of guide portions 417 can be spaced and arranged in parallel.

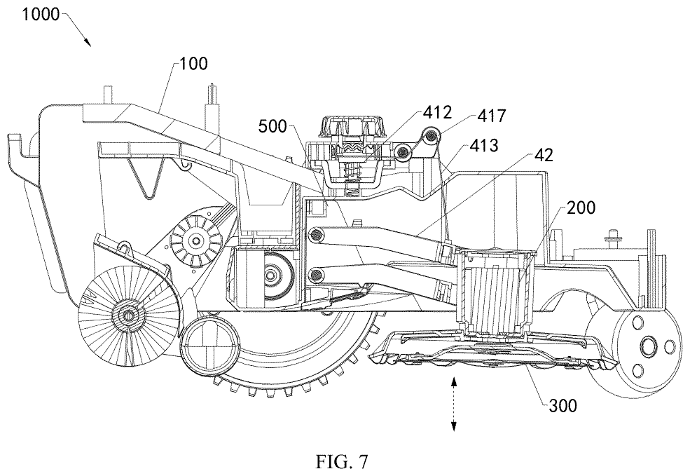

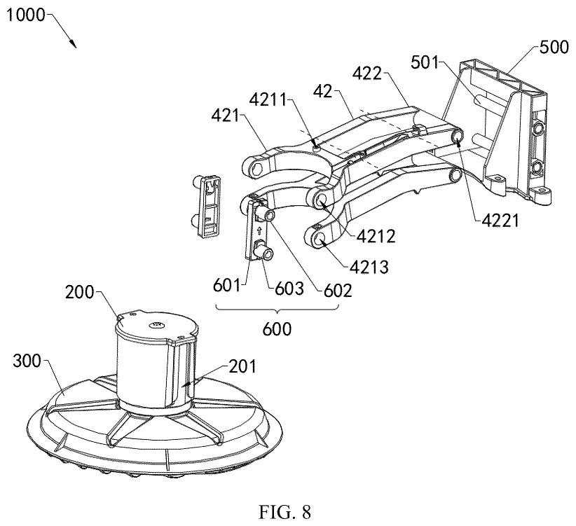

FIG. 7 is a partial cross-sectional view of an embodiment of the mowing device 1000 shown in FIG. 1 at the C-C line. FIG. 8 is a partial exploded view of the partial structure of the mowing device 1000 shown in FIG. 1.

As shown in FIGS. 7 and 8, A first end of the cord 413 is connected to the rotating shaft 412, and a second end of the cord 413 is connected to the swing arm 42.

Exemplarily, the swing arm 42 has a first end 421 and a second end 422 arranged opposite to each other. FIG. 8 schematically distinguishes the first end 421 and the second end 422 of the swing arm 42 by a dotted line. The first end 421 of the swing arm 42 is provided with a connection hole 4211. The cord 413 can be fixed in the connection hole 4211.

It can be understood that when the rotating shaft 412 is in the first position, the cord 413 is fixed relative to the rotating shaft 412 and the swing arm 42 is fixed relative to the vehicle body 100. When the rotating shaft 412 rotates relative to the fixing frame 411, thereby the cord 413 is wound around the cord roller portion 4124 or detached from the cord roller portion 4124, the cord 413 can drive the swing arm 42 to swing relative to the vehicle body 100.

As shown in FIGS. 7 and 8, the cord 413 can be wound around the guide portion 417. It can be understood that the cord 413 is wound around the guide portion 417 to change a direction of the tension between the cord 413 and the swing arm 42, so as to better guide the winding of the cord 413 on the rotating shaft 412 and pull the swing arm 42 more smoothly, making it easier to pull the swing arm 42. Exemplarily, a direction of tension between the cord 413 and the swing arm 42 can be perpendicular or approximately perpendicular to the swing direction of the swing arm 42.

It can be understood that when the tension direction between the cord 413 and the swing arm 42 is perpendicular or approximately perpendicular to the swing direction of the swing arm 42, it is more labor-saving to pull the swing arm 42 by the cord 413, and it is easier to pull the swing arm 42 to swing relative to the vehicle body 100.

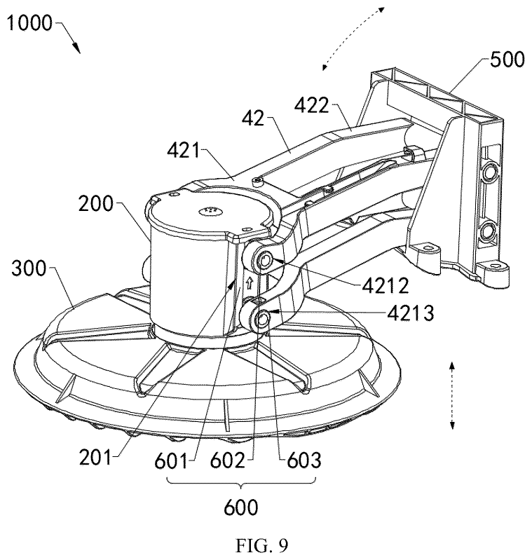

FIG. 9 is a partial schematic diagram of the mowing device 1000 shown in FIG. 1. Exemplarily, FIG. 9 illustrates a schematic diagram of the assembly between the swing arm 42, the motor 200, and the cutter disc 300.

As shown in FIGS. 7 to 9, the second end 422 of the swing arm 42 is swing-connected to the vehicle body 100. The swing arm 42 can swing relative to the vehicle body 100.

Exemplarily, the lifting mechanism 400 may further include a fixing seat 500. The fixing seat 500 is fixedly connected to the vehicle body 100 of the mowing device 1000. A first end of the swing arm 42 is rotatably connected to the fixing seat 500.

Exemplarily, the fixing seat 500 is provided with a fixed shaft 501. The second end 422 of the swing arm 42 is provided with a through hole 4221. The fixed shaft 501 of the fixing seat 500 can be inserted into the through hole 4221 of the swing arm 42.

In other embodiments, the swing arm 42 may be provided with a fixed shaft. The fixing seat 500 can be provided with a through hole. The fixed shaft of the swing arm 42 can be inserted into the through hole of the fixing seat 500.

It can be understood that when the rotating shaft 412 is in the first position, the rotating shaft 412 is locked relative to the fixing frame 411, thereby the swing arm 42 is fixed relative to the vehicle body 100. When the rotating shaft 412 is in the second position, the rotating shaft 412 can rotate relative to the fixing frame 411 to drive the cord 413 to wind around the cord roller portion 4124 or disengage from the cord roller portion 4124, thereby the swing arm 42 swings relative to the vehicle body 100, thereby driving the motor 200 and the cutter disc 300 away from or close to the ground.

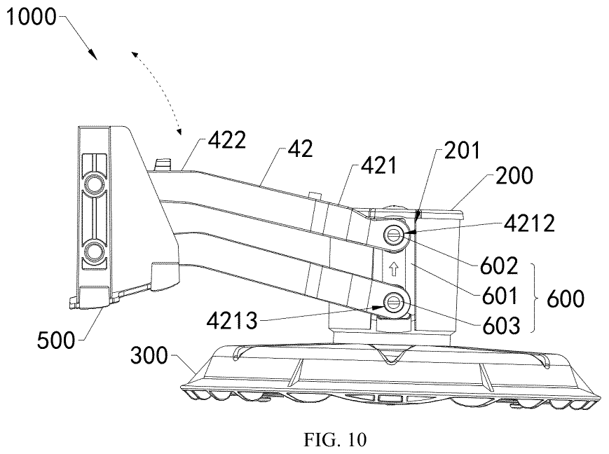

FIG. 10 is a schematic diagram illustrating a structure of the mowing device 1000 shown in FIG. 9 at different angles.

As shown in FIGS. 8 to 10, the first end 421 of the swing arm 42 is connected to the motor 200.

Exemplarily, the lifting mechanism 400 may further include a connecting block 600. The first end 421 of the swing arm 42 is rotatably connected to the connecting block 600. The connecting block 600 is fixedly connected to the motor 200.

Exemplarily, the connecting block 600 comprises a main body 601, a first protrusion 602, and a second protrusion 603. The first protrusion 602 and the second protrusion 603 are fixed to the same side of the main body 601. The first protrusion 602 and the second protrusion 603 can be arranged at intervals along the length direction of the main body 601.

Exemplarily, the first end 421 of the swing arm 42 has a first through hole 4212 and a second through hole 4213. At least part of the first protrusion 602 can be located in the first through hole 4212. At least part of the second protrusion 603 can be located in the second through hole 4213.

Exemplarily, the peripheral side wall of the motor 200 may have a slide groove 201. At least part of the main body 601 of the connecting block 600 can be located in the slide groove 201. It can be understood that the connecting block 600 can slide into the slide groove 201 from the side of the slide groove 201 close to the cutter disc 300.

It can be understood that the disclosure sets at least part of the first protrusion 602 to be located in the first through hole 4212, and at least part of the second protrusion 603 to be located in the second through hole 4213, thereby when the swing arm 42 swings relative to the vehicle body 100, the connecting block 600 rotates relative to the swing arm 42, but does not swing relative to the vehicle body 100, thereby the motor 200 and the cutter disc 300 do not swing relative to the vehicle body 100. The stability of the mowing device 1000 is good.

It can be understood that when assembling the motor 200, the cutter disc 300 and the swing arm 42, the connecting block 600 can be first connected to the swing arm 42, then mounted in the slide groove 201, and finally the cutter disc 300 is mounted on the motor 200, thereby completing the installation between the motor 200, the cutter disc 300 and the swing arm 42. The installation and disassembly between the motor 200, the cutter disc 300, and the swing arm 42 are simple and convenient.

Exemplarily, the quantity of slide grooves 201 can be two. The two slide grooves 201 are arranged opposite to each other. It can be understood that when the quantity of slide grooves 201 is two, the connection between the swing arm 42 and the motor 200 is more stable and the motor 200 is not easy to shake.

In an embodiment, the motor 200 may include a housing and a body. The body can be located inside the shell. The cutter disc 300 can be connected to the bottom of the housing and electrically connected to the body. The peripheral side wall of the housing may be provided with a slide groove 201.

The lifting mechanism 400 of the embodiment of the disclosure is rotatably mounted on the fixing frame 411 by the rotating shaft 412, and the rotating shaft 412 is movable relative to the fixing frame between a first position and a second position, thereby when the rotating shaft 412 is in the first position, the rotating shaft 412 is locked relative to the fixing frame 411. At the moment, the user can press the adjustment button 416, and the rotating shaft 412 will be subjected to an external force from the first position to the second position. When the external force is greater than the elastic force of the elastic part 414, the rotating shaft 412 compresses the elastic part 414 and slides relative to the fixing frame 411. When the rotating shaft 412 slides to the second position, the locking portion 4122 is disengaged from the stop portion 4113, and the rotating shaft 412 can rotate relative to the fixing frame 411. At the moment, the user can drive the rotating shaft 412 to rotate by rotating the adjustment button 416, thereby the cord 413 is wound around the cord roller portion 4124 or detached from the cord roller portion 4124, thereby driving the swing arm 42 to swing relative to the vehicle body 100. When the rotating shaft 412 is no longer subjected to external force or the external force is less than the elastic force of the elastic part 414, the rotating shaft 412 slides from the second position to the first position under the elastic force of the elastic part 414 until the locking portion 4122 is engaged with the stop portion 4113, and the rotating shaft 412 is locked relative to the fixing frame 411. At the moment, the swing arm 42 is fixed relative to the vehicle body 100.

It can be understood that since the rotating shaft 412 and the fixing frame 411 are gear-matched, the rotating shaft 412 rotates relative to the fixing frame 411 in a stepped rotation. The lifting mechanism 400 can adjust the mowing height of the cutter disc 300 in stages according to established design requirements. Specifically, the rotation angle of the rotating shaft 412 relative to the fixing frame 411 is a number of fixed values, and the rotating shaft 412 rotates relative to the fixing frame 411 at a certain rotation angle, thereby the cord 413 can have a preset contraction length, thereby the swing arm 42 can swing relative to the vehicle body 100 at a preset angle, and then the motor 200 and the cutter disc 300 can be at a preset height from the ground.

Therefore, the rotating shaft 412 rotates stepwise relative to the fixing frame 411, thereby the cord 413 can have a preset contraction length, thereby the swing arm 42 can swing relative to the vehicle body 100 at a preset angle, and then the motor 200 and the cutter disc 300 can be at a preset height above the ground, and the lifting mechanism 400 can have a plurality of adjustment gears.

The lifting mechanism 400 of the embodiment of the disclosure can realize the lifting function of the cutter disc 300 through the cooperation of the rotating shaft 412, the cord 413 and the swing arm 42. The overall structure and manufacturing process are relatively simple, easy to install, and can effectively reduce costs. On the other hand, the lifting mechanism 400 offers easy adjustment, high control accuracy, and robust stability. The lifting mechanism 400 is applied to the mowing device 1000, and the height of the motor 200 and the cutter disc 300 from the ground is controlled by the swing arm 42, thereby the mowing height of the mowing device 1000 can be better controlled with good control accuracy.

It should be noted that, without conflict, the embodiments and features in the embodiments of the disclosure can be combined with each other, and any combination of features in different embodiments is also within the scope of protection of the disclosure. That is to say, the plurality of embodiments described above can be further arbitrarily combined according to actual needs.

It should be noted that all the preceding drawings are exemplary diagrams of the disclosure and do not represent the actual size of the product. And the size ratio relationship between the components in the drawings is not used as a limitation on the actual product of the disclosure.

The above descriptions are merely specific embodiments of the disclosure and are not intended to limit the scope of protection of the disclosure. Any modifications or substitutions easily conceivable by those skilled in the art within the scope of the disclosed technical content shall fall within the scope of protection of the disclosure. Therefore, the scope of protection of the disclosure shall be defined by the scope of protection of the claims.

What is claimed is:

1. A lifting mechanism, applied to a lawn mowing device, comprising:
a swing arm being configured to swing relative to the mowing device, the swing arm mounted on the mowing device; and
an adjustment assembly, wherein the adjustment assembly comprises a fixing frame, a rotating shaft, and a cord, the fixing frame is fixedly mounted on the mowing device, the rotating shaft is rotatably mounted on the fixing frame and is movable relative to the fixing frame between a first position and a second position, a first end of the cord is connected to the rotating shaft, and a second end of the cord is connected to the swing arm;
wherein when the rotating shaft is in the first position, the rotating shaft is locked relative to the fixing frame; and
when the rotating shaft is in the second position, the rotating shaft is configured to rotate relative to the fixing frame to drive the cord to actuate swinging of the swing arm.

2. The lifting mechanism according to claim 1, wherein the fixing frame is provided with a stop portion, and the rotating shaft is provided with a locking portion; when the rotating shaft is in the first position, the stop portion is engaged with the locking portion to lock the rotating shaft; and when the rotating shaft is in the second position, the stop portion is disengaged from the locking portion to allow the rotating shaft to rotate.

3. The lifting mechanism according to claim 2, wherein the locking portion has a plurality of first teeth, the plurality of first teeth circumferentially arranged along the rotating shaft, and the stop portion has a plurality of second teeth opposite to the first teeth;
when the rotating shaft is in the first position, the plurality of first teeth are engaged with the plurality of second teeth; and
when the rotating shaft is in the second position, the plurality of first teeth are disengaged from the plurality of second teeth.

4. The lifting mechanism according to claim 2, wherein the adjustment assembly further comprises an elastic part, the elastic part is sleeved on the rotating shaft and exerts an elastic force on the rotating shaft to slide it from the second position to the first position.

5. The lifting mechanism according to claim 4, wherein the adjustment assembly further comprises a support frame fixedly connected to the fixing frame, and a first end of the elastic part abuts the locking position, a second end of the elastic part abuts the support frame.

6. The lifting mechanism according to claim 5, wherein the support frame comprises a bottom wall, a first connecting arm, and a second connecting arm, a first end of the first connecting arm and a first end of the second connecting arm are respectively connected to both ends of the bottom wall and bent toward the fixing frame; and
a second end of the first connecting arm and a second end of the second connecting arm are fixedly connected to the fixing frame, the bottom wall is located on the side of the locking portion facing away from the fixing frame, and the elastic part is abutted between the bottom wall and the locking portion.

7. The lifting mechanism according to claim 1, wherein the rotating shaft is further provided with a cord roller portion, A first end of the cord is connected to the cord roller portion, and the cord is at least partially wound around the cord roller portion.

8. The lifting mechanism according to claim 1, wherein a guide portion is provided on the fixing frame, and the cord is wound around the guide portion to change a direction of tension between the cord and the swing arm.

9. The lifting mechanism according to claim 1, wherein the adjustment assembly further comprises an adjustment button, the fixing frame is provided with a through hole, the rotating shaft extends through the through hole and at least partially extends out of the through hole, and the adjustment button is mounted on an extended end of the rotating shaft and is spaced apart from the fixing frame.

10. A mowing device, comprising a vehicle body, a motor, a cutter disc, and a lifting mechanism, wherein the lifting mechanism comprising:
a swing arm being configured to swing relative to the mowing device, the swing arm mounted on the mowing device; and
an adjustment assembly, wherein the adjustment assembly comprises a fixing frame, a rotating shaft, and a cord, the fixing frame is fixedly mounted on the mowing device, the rotating shaft is rotatably mounted on the fixing frame and is movable relative to the fixing frame between a first position and a second position, a first end of the cord is connected to the rotating shaft, and a second end of the cord is connected to the swing arm;
wherein when the rotating shaft is in the first position, the rotating shaft is locked relative to the fixing frame; and
when the rotating shaft is in the second position, the rotating shaft is configured to rotate relative to the fixing frame to drive the cord to actuate swinging of the swing arm;
the adjustment assembly is mounted on the vehicle body, a first end of the swing arm is connected to the vehicle body for swinging, a second end of the swing arm is connected to the motor, and the cutter disc is mounted on the motor.

11. The mowing device according to claim 10, wherein the fixing frame is provided with a stop portion, and the rotating shaft is provided with a locking portion; when the rotating shaft is in the first position, the stop portion is engaged with the locking portion to lock the rotating shaft; and when the rotating shaft is in the second position, the stop portion is disengaged from the locking portion to allow the rotating shaft to rotate.

12. The mowing device according to claim 11, wherein the locking portion has a plurality of first teeth, the plurality of first teeth circumferentially arranged along the rotating shaft, and the stop portion has a plurality of second teeth opposite to the first teeth;
when the rotating shaft is in the first position, the plurality of first teeth are engaged with the plurality of second teeth; and
when the rotating shaft is in the second position, the plurality of first teeth are disengaged from the plurality of second teeth.

13. The mowing device according to claim 11, wherein the adjustment assembly further comprises an elastic part, the elastic part is sleeved on the rotating shaft and exerts an elastic force on the rotating shaft to slide it from the second position to the first position.

14. The mowing device according to claim 13, wherein the adjustment assembly further comprises a support frame fixedly connected to the fixing frame, and a first end of the elastic part abuts the locking position, a second end of the elastic part abuts the support frame.

15. The mowing device according to claim 14, wherein the support frame comprises a bottom wall, a first connecting arm, and a second connecting arm, a first end of the first connecting arm and a first end of the second connecting arm are respectively connected to both ends of the bottom wall and bent toward the fixing frame; and
a second end of the first connecting arm and a second end of the second connecting arm are fixedly connected to the fixing frame, the bottom wall is located on the side of the locking portion facing away from the fixing frame, and the elastic part is abutted between the bottom wall and the locking portion.

16. The mowing device according to claim 10, wherein the rotating shaft is further provided with a cord roller portion, A first end of the cord is connected to the cord roller portion, and the cord is at least partially wound around the cord roller portion.

17. The mowing device according to claim 10, wherein a guide portion is provided on the fixing frame, and the cord is wound around the guide portion to change a direction of tension between the cord and the swing arm.

18. The mowing device according to claim 10, wherein the adjustment assembly further comprises an adjustment button, the fixing frame is provided with a through hole, the rotating shaft extends through the through hole and at least partially extends out of the through hole, and the adjustment button is mounted on an extended end of the rotating shaft and is spaced apart from the fixing frame.
